(19) United States
(12) Patent Application Publication
(10) Pub. No.: US 2007/0176884 A1
(43) Pub. Date: Aug. 2, 2007

(54) LIQUID CRYSTAL DISPLAY DEVICE, AND DRIVING CIRCUIT AND DRIVING METHOD USED IN SAME

(75) Inventor: Mitsuasa TAKAHASHI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 11/626,949

(22) Filed: Jan. 25, 2007

(30) Foreign Application Priority Data
Feb. 1, 2006 (JP) 2006-024416

(51) Int. Cl. G09G 3/36

(52) U.S. Cl. 345/102

(57) ABSTRACT

A liquid crystal display device is provided which is capable of improving display quality of moving images. In the liquid crystal display device, every time a driving pulse voltage is generated by a backlight driving circuit in synchronization with a timing signal fed from a lighting timing control section and is applied to a backlight and a scanning signal is applied to each scanning electrode of a liquid crystal panel, the backlight is turned OFF during a period before completion of a response of each liquid crystal molecule to application of a display signal and is turned ON at time of the completion of the response. When displacement of each of the liquid crystal molecules is large and therefore the change in light transmittance is large, the backlight is turned OFF and, therefore, no change in luminance on a display screen occurs, as a result, contrast of images can be improved.

### BACKGROUND OF THE INVENTION

1. Field of the Invention

The present invention relates to a liquid crystal display device and a driving circuit and a driving method to be used for the liquid crystal display device and more particularly to the liquid crystal display device that can be suitably employed when moving images are displayed and to the driving circuit and the driving method that can be employed for the liquid crystal display device.

The present application claims priority of Japanese Patent Application No. 2006-024416 filed on Feb. 1, 2006, which is hereby incorporated by reference.

2. Description of the Related Art

A liquid crystal display device is generally driven in a holding-type manner in which a current frame is held until display data corresponding to a succeeding frame is supplied. In this case, a device used to mainly display a still image such as a personal computer or a like presents no problem. However, in the case of a display device to display moving images such as a liquid crystal television set, a subsequent image is displayed with a current image being still left in the consciousness of a user and, as a result, the current image is perceived by a user as an afterimage. On the other hand, a CRT (Cathode Ray Tube) display device is generally called an “Impulse-type” display device in which, immediately after light is intensively emitted for an instant, light disappears, and nothing is displayed until subsequent displaying starts. This operation is repeated, for example, at the frequency of 60 times per second. Thus, subsequent displaying does not start until an image previously displayed disappears and, therefore, in the case of displaying moving images, persistence of vision is less perceived by a user. Due to this, in the liquid crystal display device, in the liquid crystal television set in particular, by providing a period for which a backlight is turned OFF at the latter half of each successive frame to perform impulse-type driving of the backlight, contrast of moving images is improved.

The conventional liquid crystal display device of such a type, as shown in FIG. 7, includes a control section 1, a data electrode driving circuit 2, a scanning electrode driving circuit 3, a liquid crystal panel 4, a backlight 5, a lighting timing control section 6, and a backlight driving circuit 7. The liquid crystal panel 4 has data electrodes (not shown), scanning electrodes (not shown), and pixel regions (not shown). To the scanning electrodes is sequentially supplied a scanning signal “OUTⱼ”. To the data electrodes is supplied a corresponding display signal “Dᵢ” and, therefore, to the pixel regions is supplied the display signal “Dᵢ”. As a result, a state of orientation of a liquid crystal molecule making up a liquid crystal layer of the liquid crystal panel 4 is controlled by the display signal “Dᵢ”, thus changing transmittance of light, thereby enabling a display image to be obtained. The data electrode driving circuit 2 feeds, based on a control signal “a” supplied from the control section 1, the display signal “Dᵢ” corresponding to a video input signal “VD” to each data electrode of the liquid crystal panel 4. The scanning electrode driving circuit 3 feeds, based on a control signal “b” supplied from the control section 1, the scanning signal “OUTⱼ” line-sequentially to each scanning electrode of the liquid crystal panel 4.

The lighting timing control section 6 generates, based on a control signal “c” fed from the control section 1, a timing signal “d” to turn ON/OFF the backlight 5. The backlight driving circuit 7 generates a driving pulse voltage “e” using, for example, a commercial power supply in synchronization with the timing signal “d” and applies the generated driving pulse voltage “e” to the backlight 5. The backlight 5 includes six backlights 5₁, 5₂, 5₃, 5₄, 5₅, and 5₆ each being made up of, for example, a cold cathode tube, an LED (Light Emitting Diode), or a like, all of which are driven by one operation. The control section 1 sends out, based on the video input signal “VD”, the control signal “a” to the data electrode driving circuit 2, the control signal “b” to the scanning electrode driving circuit 3, and the control signal “c” to the lighting timing control section 6.

In the above conventional liquid crystal display device, as shown in FIG. 8, within time T1 corresponding to an n-th frame of the video input signal “VD”, a turning-OFF period T12 is set after a turning-ON period T11 for the backlight 5 (5₁, 5₂, . . . , 5₆) and, thereafter, within time T2 corresponding to an (n+1)-th frame of the video input signal “VD”, a turning-OFF period T22 is set after a turning-ON period T21 for the backlight 5 (5₁, 5₂, . . . , 5₆). Thus, all of the backlights 5₁, 5₂, 5₃, 5₄, 5₅, and 5₆ are impulse-driven by one operation. This enables, as shown in FIG. 9, each of black screens “g” to be inserted among each pair of display screens “f”, thereby achieving improvement of contrast of images on the display screen for moving images. In addition to the liquid crystal display devices in which the backlight is impulse-driven, there are some liquid crystal display devices in which driving of black writing is performed at the latter half of each frame. In this case, as in the case shown in FIG. 9, each of the black screens “g” is inserted among each pair of the display screens “f”.

Besides the liquid crystal display devices described above, other liquid crystal display devices of this type are disclosed, for example, in the following references.

A conventional liquid crystal display device is disclosed in prior art Patent Reference 1 [Japanese Patent Application Laid-open No. 2000-275605 (Abstract, FIG. 1)] in which an entire region of a display screen of a liquid crystal panel is divided into a plurality of portions and a rear light source is also divided into a plurality of portions in a manner to correspond to the divided portions of the liquid crystal panel. A rear light source driving section exercises control so that the divided portions of the rear light source corresponding to the divided portions of the liquid crystal panel are turned OFF during a response transition period of a liquid crystal. As a result, each of the divided portions of the rear light source is turned ON/OFF according to a plurality of scanning electrodes of the liquid crystal panel.

Another conventional liquid crystal panel is disclosed in prior art Patent Reference 2 [Japanese Patent Application Laid-open No. 2000-321993 (Abstract, FIG. 4)] in which a plurality of fluorescent tubes is mounted on a rear side of a liquid crystal display panel and, after a lapse of a specified time following overwriting of each pixel line of the liquid crystal display panel, fluorescent tubes corresponding to the overwritten pixel lines are turned ON. This can prevent blurring of moving pictures. In this case, each of the fluorescent tubes is turned ON/OFF in a manner to correspond to a plurality of scanning electrodes of the liquid crystal display panel.

Still another conventional liquid crystal display device is disclosed in prior art Patent Reference 3 [Japanese Patent Application Laid-open No. 2004-062134 (Abstract, FIG. 1)] in which a feature amount of an image signal to be displayed during a vertical period is detected and turning-ON time of a backlight is variably controlled. This allows intermittent driving of the backlight to be controlled according to contents of a display image, thereby achieving an improvement of an image quality by preventing blurring of moving images and by modulating peak luminance. In this case, the backlight is turned ON/OFF in a manner to correspond to a plurality of scanning electrodes of a liquid crystal display panel.

Furthermore, still another conventional liquid crystal display device is disclosed in prior art Patent Reference 4 [Japanese Patent Application Laid-open No. 2005-134724 (Abstract, FIG. 1)] in which a scanning line is detected on which image data is to be written according to vertical/horizontal synchronizing signals of image data and, based on results from the detection, gray level conversion of the image data is made so that display luminance determined by each image data becomes approximately the same during an image display period for every scanning line. Owing to this, when a backlight is driven intermittently during one frame period, occurrence of a difference in display luminance for every scanning line can be prevented, thereby achieving high quality image display. In this case, the backlight is turned ON/OFF in a manner to correspond to a plurality of scanning electrodes of a liquid crystal panel.

However, these conventional liquid crystal devices have the following problems. That is, in the conventional liquid crystal display device shown in FIG. 7, the turning-OFF period of the backlight 5 is provided at the latter half of each frame and impulse-driving is performed to improve contrast of images. However, during a period before completion of the response of liquid crystal molecules in each display region, since light from the backlight 5 is transmitted through the liquid crystal molecules, a difference occurs between a gray level of a display screen and a finally set gray level, as a result, causing a decrease in contrast in images. Moreover, the turning-OFF period of the backlight 5 is already in a steady state and, therefore, the improvement of contrast of images is achieved only by impulse-driving, making it difficult to achieve sufficient improvement.

Also, in the liquid crystal display device disclosed in the prior art Patent Reference 1, each of the display screen and the rear light source is divided into a plurality of regions and each divided portion of the rear light source is turned ON/OFF in a manner to correspond to the plurality of scanning electrodes of the liquid crystal panel and, therefore, though the purpose and effect of the invention described in the prior art Patent Reference 1 are similar to those of the present invention, configurations and operations are different from one another.

In the display panel disclosed in the prior art Patent Reference 2, after a lapse of a specified time following overwriting of each pixel line of the liquid crystal display panel, fluorescent tubes corresponding to the overwritten pixel line are turned ON and, therefore, though the purpose and effect of the invention described in the prior art Patent Reference 1 are similar to those of the present invention. However, in the conventional display panel, each of the fluorescent tubes is turned ON/OFF in a manner to correspond to a plurality of scanning electrodes of the liquid crystal display panel and, therefore, in this case, also configurations and operations are different from one another.

In the display panel disclosed in the prior art Patent Reference 3, the turning-ON time of the backlight is variably controlled based on a feature amount of an image signal and the backlight is turned ON/OFF in a manner to correspond to a plurality of scanning electrodes of the liquid crystal display panel and, therefore, configurations and operations are different from one another.

In the liquid crystal display device disclosed in the prior art Patent Reference 4, occurrence of a difference in display luminance for every scanning line is prevented. However, the problems described above cannot be solved. Moreover, also in the liquid crystal display device, the backlight is turned ON/OFF in a manner to correspond to a plurality of scanning electrodes and, therefore, configurations and operations are different from one another.

### SUMMARY OF THE INVENTION

In view of the above, it is an object of the present invention to provide a liquid crystal display device which is capable of improving contrast of images on a display screen for moving images.

According to a first aspect of the present invention, there is provided a liquid crystal display device including:

a light source,

a light source controlling unit, and

a liquid crystal panel,

wherein the liquid crystal panel includes:

an active matrix substrate having a plurality of data electrodes arranged in parallel with one another at predetermined intervals along a first direction, a plurality of scanning electrodes arranged in parallel with one another at predetermined intervals along a second direction orthogonal to the first direction, and a plurality of pixel regions each being arranged in a manner to correspond, in a one-to-one relationship, to an intersection of the two electrodes, one being each of the plurality of data electrodes and another being each of the plurality of scanning electrodes;

a facing substrate mounted in a manner to face the active matrix substrate which has facing electrodes; and

a liquid crystal layer interposed between the active matrix substrate and the facing substrate; and

wherein, by application of a scanning signal to each of the plurality of scanning electrodes and of a display signal to each of the plurality of data electrodes, a specified voltage is applied to each of the plurality of pixel regions corresponding to the display signal and an orientation state of each liquid crystal molecule making up the liquid crystal layer is controlled by the voltage to be applied to obtain a display image; and

wherein the light source controlling unit controls timing of turning the light source ON/OFF according to a response characteristic of each liquid crystal molecule to an applied voltage.

In the foregoing, a preferable mode is one wherein the light source controlling unit turns the light source OFF during a period before completion of the response of each liquid crystal molecule to the application of the display signal and turns the light source ON at time of the completion of the response.

Also, a preferable mode is one that wherein includes a data electrode driving circuit to apply a corresponding display signal, by one operation, to each of the plurality of data electrodes of the liquid crystal panel; and

a scanning electrode driving circuit to apply the scanning signal line-sequentially to each of the plurality of scanning electrodes of the liquid crystal panel;

wherein, every time the scanning signal is applied to each of the plurality of scanning electrodes, the light source controlling unit turns OFF and ON the light source.

Also, a preferable mode is one that wherein includes a data electrode driving circuit to apply a corresponding display signal point-sequentially to each of the plurality of data electrodes of the liquid crystal panel; and

a scanning electrode driving circuit to apply the scanning signal line-sequentially to each of the plurality of scanning electrodes of the liquid crystal panel;

wherein, every time the display signal is applied to each of the plurality of data electrodes, the light source controlling unit turns OFF and ON the light source.

According to a second aspect of the present invention, there is provided a driving circuit for being used in a liquid crystal display device including:

a light source,

a light source controlling unit, and

a liquid crystal panel,

wherein the liquid crystal panel includes:

an active matrix substrate having a plurality of data electrodes arranged in parallel with one another at predetermined intervals along a first direction, a plurality of scanning electrodes arranged in parallel with one another at predetermined intervals along a second direction orthogonal to the first direction, and a plurality of pixel regions each being arranged in a manner to correspond, in a one-to-one relationship, to an intersection of the two electrodes, one being each of the plurality of data electrodes and another being each of the plurality of scanning electrodes;

a facing substrate mounted in a manner to face the active matrix substrate which has facing electrodes; and

a liquid crystal layer interposed between the active matrix substrate and the facing substrate; and

wherein, by application of a scanning signal to each of the plurality of scanning electrodes and of a display signal to each of the plurality of data electrodes, a specified voltage is applied to each of the plurality of pixel regions corresponding to the display signal and an orientation state of each liquid crystal molecule making up the liquid crystal layer is controlled by the voltage to be applied to obtain a display image; and

wherein the light source controlling unit controls timing of turning the light source ON/OFF according to a response characteristic of each liquid crystal molecule to an applied voltage.

In the foregoing, a preferable mode is one wherein the light source controlling unit turns the light source OFF during a period before completion of the response of each liquid crystal molecule to the application of the display signal and turns the light source ON at time of the completion of the response.

Also, a preferable mode is one that wherein includes a data electrode driving circuit to apply a corresponding display signal, by one operation, to each of the plurality of data electrodes of the liquid crystal panel; and

a scanning electrode driving circuit to apply the scanning signal line-sequentially to each of the plurality of scanning electrodes of the liquid crystal panel;

wherein, every time the scanning signal is applied to each of the plurality of scanning electrodes, the light source driving unit turns the light source OFF and ON.

Also, a preferable mode is one that wherein includes a data electrode driving circuit to apply a corresponding display signal, point-sequentially, to each of the plurality of data electrodes of the liquid crystal panel; and

a scanning electrode driving circuit to apply the scanning signal line-sequentially to each of the plurality of scanning electrodes of the liquid crystal panel;

wherein, every time the scanning signal is applied to each of the plurality of scanning electrodes, the light source driving unit turns the light source OFF and ON.

According to a third aspect of the present invention, there is provided a driving method for driving a liquid crystal display device including a light source, a light source controlling unit, and a liquid crystal panel, wherein the liquid crystal panel includes an active matrix substrate having a plurality of data electrodes arranged in parallel with one another at predetermined intervals along a first direction, a plurality of scanning electrodes arranged in parallel with one another at predetermined intervals along a second direction orthogonal to the first direction, and a plurality of pixel regions each being arranged in a manner to correspond, in a one-to-one relationship, to an intersection of the two electrodes, one being each of the plurality of data electrodes and another being each of the plurality of scanning electrodes, a facing substrate mounted in a manner to face the active matrix substrate which has facing electrodes, a liquid crystal layer interposed between the active matrix substrate and the facing substrate, and wherein, by application of a scanning signal to each of the plurality of scanning electrodes and of a display signal to each of the plurality of data electrodes, a specified voltage is applied to each of the plurality of pixel regions corresponding to the display signal and an orientation state of each liquid crystal molecule making up the liquid crystal layer is controlled by the voltage to be applied to obtain a display image, the driving method including:

light source driving processing in which timing of turning the light source ON/OFF is controlled according to a response characteristic of each liquid crystal molecule to an applied voltage.

In the foregoing, a preferable mode is one wherein, in the light source driving processing, the light source is turned OFF during a period before completion of the response of each liquid crystal molecule to the application of the display signal and is turned ON at time of the completion of the response.

Also, a preferable mode is one that wherein includes a step of mounting a data electrode driving circuit to apply a corresponding display signal, by one operation, to each of the plurality of data electrodes of the liquid crystal panel; and

a step of mounting a scanning electrode driving circuit to apply the scanning signal line-sequentially to each of the plurality of scanning electrodes of the liquid crystal panel;

wherein, in the light source driving processing, every time the display signal is applied to each of the plurality of data electrodes, the light source is turned OFF and ON.

Furthermore, a preferable mode is one that wherein includes a step of mounting a data electrode driving circuit to apply a corresponding display signal point-sequentially to each of the plurality of data electrodes of the liquid crystal panel, and a step of mounting a scanning electrode driving circuit to apply the scanning signal line-sequentially to each of the plurality of scanning electrodes of the liquid crystal panel;

wherein, in the light source driving processing, every time the scanning signal is applied to each of the plurality of scanning electrodes, the light source is turned OFF and ON.

With the above configurations, there is provided a light source controlling unit to turn the backlight ON in a manner to correspond to a response characteristic of each of liquid crystal molecules making up a liquid crystal layer to an applied voltage of a display signal and, therefore, when displacement of each of the liquid crystal molecules is large and therefore change in light transmittance is large, the light source is turned OFF, thereby preventing a change in luminance on a display screen and improving contrast of images. In addition, the light source controlling unit turns the light source OFF for a period before completion of a response of each of the liquid crystal molecules to application of a voltage of a display signal and turns the light source ON at time of the completion of the response and, therefore, when displacement of each of the liquid crystal molecules is large and therefore the change in light transmittance is large, no light from the light source is transmitted through each of the liquid crystal molecules, thereby preventing a change in luminance on a display screen and improving contrast of images. In this case, every time a scanning signal is applied to each of the scanning electrodes, the light source controlling unit turns the light source OFF and ON and, therefore, contrast can be improved. Moreover, every time a corresponding display signal is applied to each of the data electrodes, the backlight is turned OFF and ON by the light source control section and, as a result, contrast of images can be further improved.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing electrical configurations of main components of a liquid crystal display device according to a first embodiment of the present invention;

FIG. 2 is a circuit diagram showing one example of electrical configurations of the liquid crystal panel of FIG. 1;

FIG. 3 is a diagram showing one example of the liquid crystal panel of FIG. 1 in which a TN (Twisted Nematic)-type liquid crystal and a color filter is formed on a facing substrate and showing a position of a backlight;

FIG. 4 is a time chart explaining operations of the liquid crystal display device of FIG. 1;

FIG. 5 is a block diagram showing electrical configurations of main components of a liquid crystal display device according to a second embodiment of the present invention;

FIG. 6 is a time chart explaining operations of the liquid crystal display device of FIG. 5;

FIG. 7 is a block diagram showing electrical configurations of main components of a conventional liquid crystal display device;

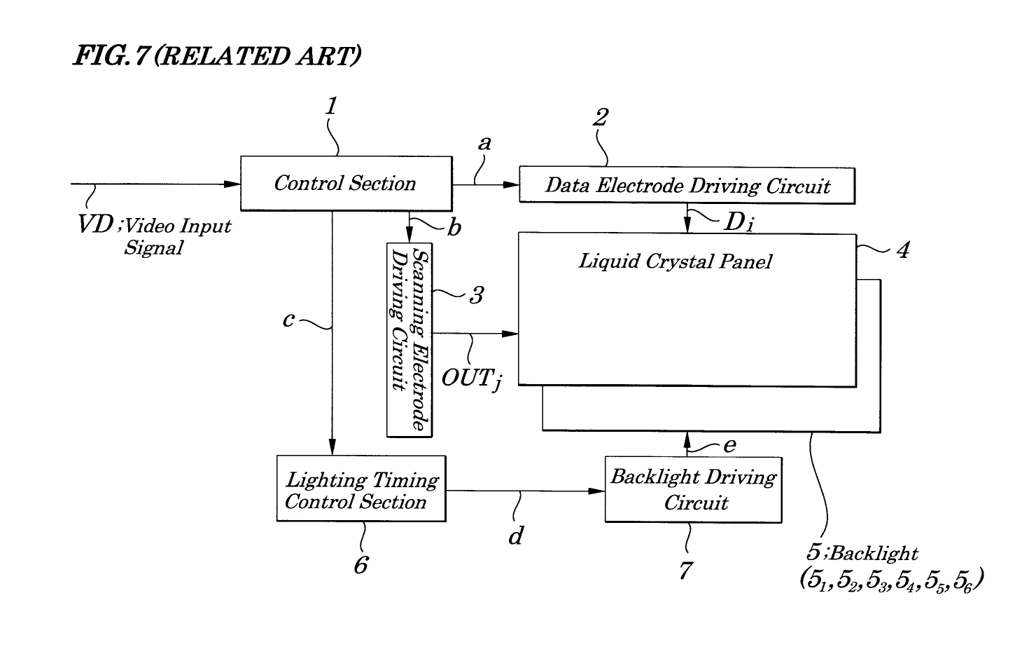

FIG. 8 is a time chart explaining operations of the conventional liquid crystal display device of FIG. 7; and

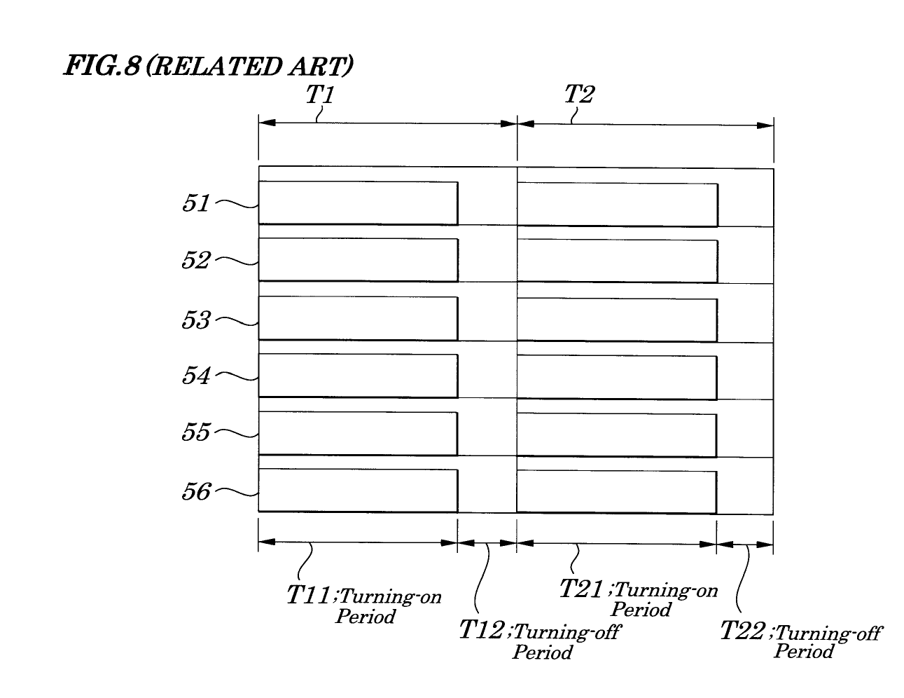

FIG. 9 is a schematic diagram explaining a display screen of moving images by using a conventional impulse driving method.

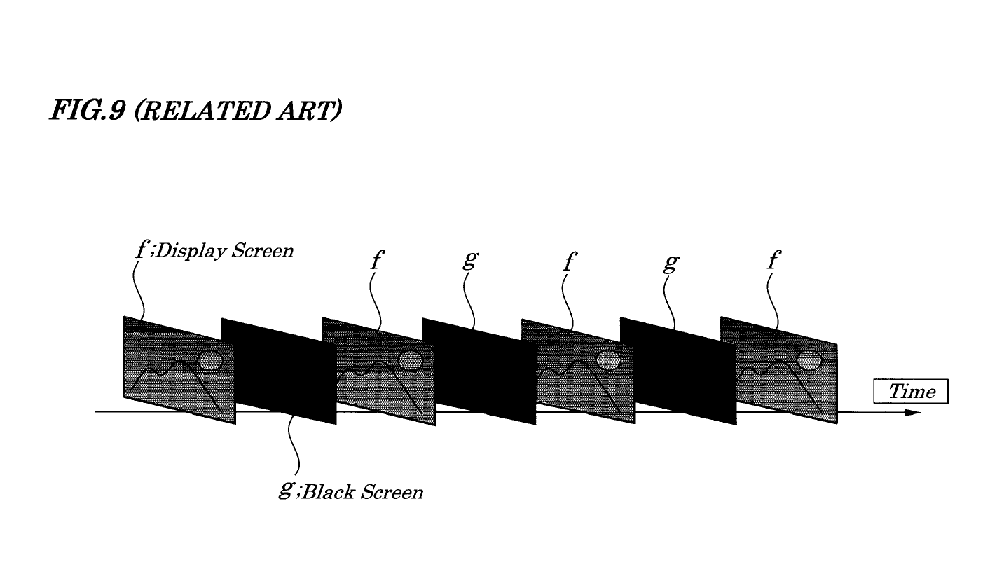

### DETAILED DESCRIPTION OF THE PREFERRED EMBODIMENTS

Best modes of carrying out the present invention will be described in further detail using various embodiments with reference to the accompanying drawings. According to the best modes of the present invention, a liquid crystal display device is provided in which, every time a scanning signal is applied line-sequentially to each scanning electrode of a liquid crystal panel or every time a corresponding display signal is applied point-sequentially to each data electrode of the liquid crystal panel, a backlight is turned OFF during a period before completion of a response of each liquid crystal molecule in response to application of the display signal and is turned ON at time of completion of the response.

### First Embodiment

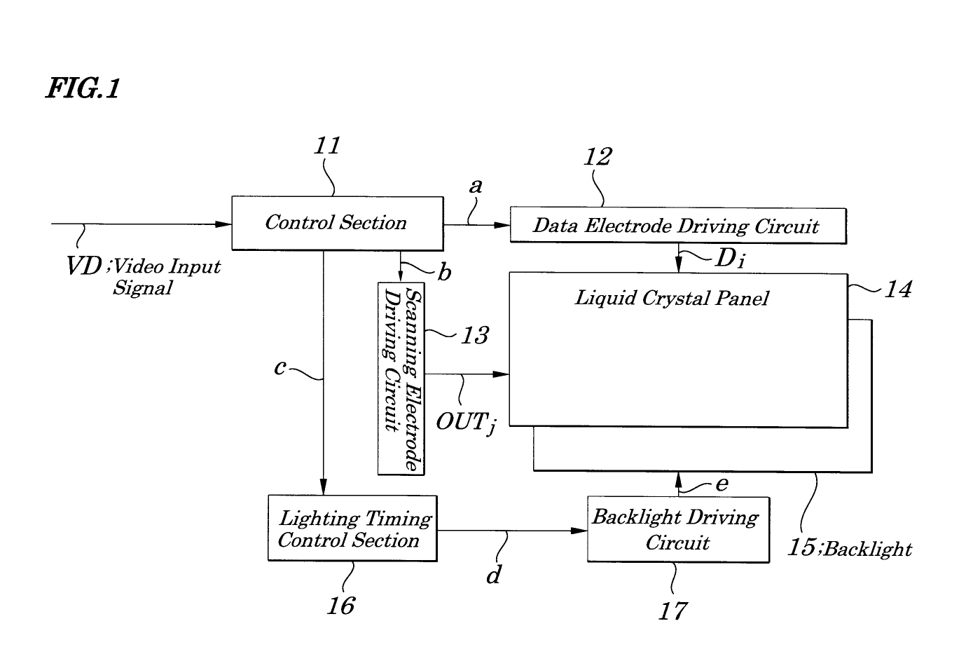

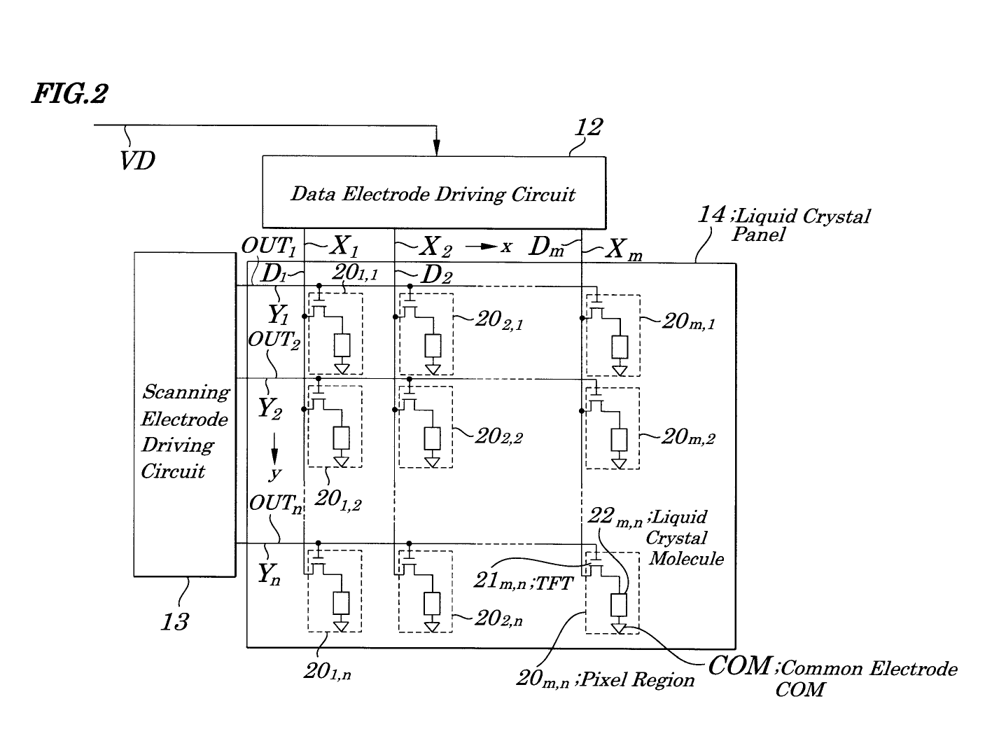

FIG. 1 is a block diagram showing electrical configurations of main components of a liquid crystal display device according to the first embodiment of the present invention. The liquid crystal display device according the first embodiment of the present invention, includes, as shown in FIG. 1, a control section 11, a data electrode driving circuit 12, a scanning electrode driving circuit 13, a liquid crystal panel 14, a backlight 15, a lighting timing control section 16, and a backlight driving circuit 17. FIG. 2 is a circuit diagram showing one example of electrical configurations of the liquid crystal panel of FIG. 1. The liquid crystal panel 14, as shown in FIG. 2, includes data electrodes Xᵢ (i=1, 2, . . . , m; for example, m=640×3), scanning electrodes Yⱼ (j=1, 2, . . . , n; for example, n=512), and pixel regions (cells) 20_{i,j}.

Each of the data electrodes Xᵢ is formed at predetermined intervals in an X direction (that is, in the first direction) to each of which a corresponding display signal Dᵢ is applied. Each of the scanning electrodes Y1 is formed at predetermined intervals in a Y direction orthogonal to the X direction to each of which a scanning signal “OUTⱼ” to write the display signal Dᵢ is applied line-sequentially. Each of the pixel regions 20_{i,j} is formed in a manner to correspond to an intersection region of each of the data electrodes Xᵢ and each of the scanning electrodes Yⱼ in a one-to-one relationship, which is made up of each of TFTs (Thin Film Transistors) 21_{i,j}, each of liquid crystal molecules 22_{i,j}, and each of common electrodes COM. Each of the TFTs 21_{i,j} is turned ON/OFF according to a scanning signal OUTⱼ and applies a display signal Dᵢ to each of the liquid crystal molecules 22_{i,j} when getting into an ON state.

In the liquid crystal panel 14, when a scanning signal OUTⱼ is line-sequentially applied to each of the scanning electrodes Yⱼ and a corresponding display signal Dᵢ is applied to each of the data electrodes Xᵢ, the display signal Dᵢ is fed to each of the liquid crystal molecules 22_{i,j} which allows an orientation state of each of the liquid crystal molecules 22_{i,j} making up a liquid crystal layer of the liquid crystal panel 14 to be controlled based on the display signal Dᵢ and, as a result, light transmittance to be changed, thereby enabling a display image to be obtained. The data electrode driving circuit 12 applies, based on a control signal “a” (FIG. 1) fed from the control section 11, a display signal Dᵢ corresponding to a video input signal “VD” to each of the data electrodes Xᵢ of the liquid crystal panel 14 by one operation. The scanning electrode driving circuit 13 applies, based on a control signal “b” fed from the control section 11, a scanning signal OUTⱼ line-sequentially to each of the scanning electrodes Yⱼ of the liquid crystal panel 14.

The lighting timing control section 16 is made up of a plurality of logical circuits and generates, based on a control signal “c” fed from the control section 11, a timing signal “d” to turn the backlight 150N in a manner to correspond to a response characteristic of each of the liquid crystal molecules 22_{i,j} to an applied voltage. In the first embodiment in particular, the lighting timing control section 16, every time a scanning signal OUTⱼ is applied to each of the scanning electrodes Yⱼ of the liquid crystal panel 14, turns the backlight 15 OFF during a period before completion of the response of each of the liquid crystal molecules 22_{i,j} in response to the application of the display signal Dᵢ and turns the backlight 150N at time of the completion of the response. The timing of turning-ON/OFF the backlight 15 is set in a manner to correspond to a response characteristic of each of the liquid crystal molecules 22_{i,j} to an applied voltage of the display signal Dᵢ and the turning-OFF period is set in a manner to correspond to a period during which displacement of the liquid crystal molecules 22_{i,j} is large and therefore the change in light transmittance is large and the turning-ON period is set in a manner to correspond to a period during which the liquid crystal molecules 22_{i,j} reach a steady state after completion of displacement of the liquid crystal molecules 22_{i,j}.

The backlight driving circuit 17 generates a driving pulse voltage “e” in synchronization with the timing signal “d” fed from the lighting timing control section 16 by using, for example, a commercial power source and applies the generated voltage to the backlight 15. The backlight 15 is made up of, for example, a cold cathode tube, an LED, or a like and is driven by the driving pulse voltage “e” fed from the backlight driving circuit 17. The control section 11 sends out, based on the video input signal “VD”, the control signal “a” to the data electrode driving circuit 12, the control signal “b” to the scanning electrode driving circuit 13, and the control signal “c” to the lighting timing control section 16.

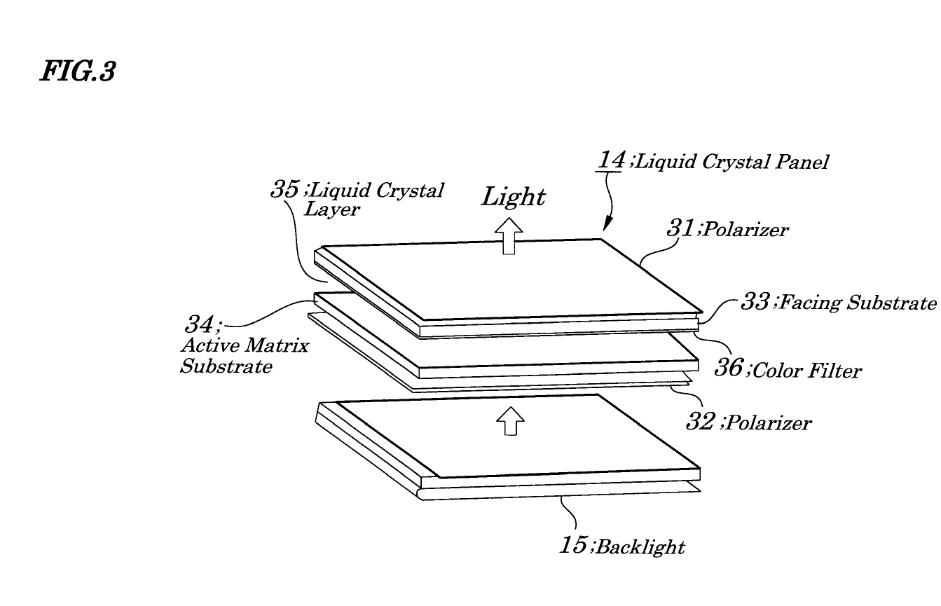

FIG. 3 is a diagram showing one example of the liquid crystal panel of FIG. 1 in which a TN-type liquid crystal and a color filter is formed on a facing substrate and showing a position of the backlight 15. The liquid crystal panel 14, as shown in FIG. 3, includes a pair of polarizers 31 and 32, a facing substrate 33, an active matrix substrate 34, a liquid crystal layer 35 interposed between the active matrix substrate 34 and the color filter 36. On a facing substrate 33 are formed the common electrode COM shown in FIG. 2 and a color filter 36 for red (R), green (G), and blue (B). One dot consists of three pixels having three colors of R, G, and B. On the active matrix substrate 34 are formed active elements such as the TFTs_{i,j} shown in FIG. 2. The backlight 15 is mounted on a rear side of the liquid crystal panel 14 and uses light of a white fluorescent lamp as a flat light source and is constructed so as to have a size being approximately the same as a display screen of the liquid crystal panel 14 as a whole.

In the liquid crystal panel 14 of the first embodiment, white light from the backlight 15, after having passed through the polarizer 32, becomes linearly polarized light and passes to the liquid crystal layer 35. The liquid crystal layer 35 is made up of, for example, the TN-type liquid crystal and operates to change a shape of polarized light, however, this operation is determined by a state of the orientation of the liquid crystal molecules and, therefore, the shape of polarized light is controlled by a voltage corresponding to the display signal Dᵢ. Whether or not outgoing light is absorbed by the polarizer 32 is determined by the shape of polarized light going out from the liquid crystal layer 35. Thus, light transmittance is controlled by a voltage corresponding to the display signal Dᵢ. Moreover, a color image is obtained by additive mixture of colors of light having passed through each of the R, G, and B pixels making up the color filter 36.

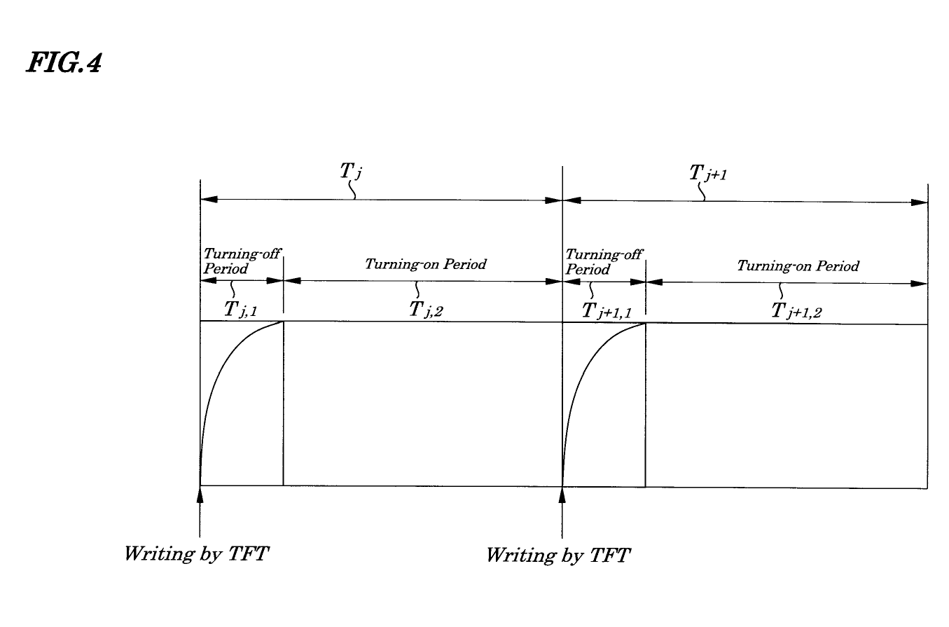

FIG. 4 is a time chart explaining operations of the liquid crystal display device shown in FIG. 1 and schematically showing a relation between a response state of each of the liquid crystal molecules 22_{i,j} and timing of turning the backlight 150N/OFF.

Referring to FIG. 4, processes for the method of driving the liquid crystal display device of the first embodiment are described below. In the liquid crystal display device, every time a driving pulse voltage is generated by the backlight driving circuit 17 in synchronization with a timing signal “d” fed from the lighting timing control section 16 and is applied to the backlight 15 and a scanning signal “OUTⱼ” is fed to each of the scanning electrodes Yⱼ of the liquid crystal panel 14, the backlight 15 is turned OFF during a period before completion of the response of each of the liquid crystal molecules 22_{i,j} in response to the application of the display signal Dᵢ and is turned ON at time of the completion of the response (light source driving process).

That is, as shown in FIG. 4, during a period Tⱼ corresponding to the j-th line in which a scanning signal “OUTⱼ” is applied to the scanning electrodes Yⱼ of the liquid crystal panel 14, a corresponding TFT 21_{i,j} is turned ON, causing the display signal Dᵢ to be fed to the liquid crystal molecules 22_{i,j} (writing by the TFT). At this time point, during a period T_{j,1} before completion of the response of each of the liquid crystal molecules 22_{i,j}, the backlight 15 is turned OFF and during a period T_{j,2} after completion of the response of each of the liquid crystal molecules 22_{i,j}, the backlight 15 is turned ON. Similarly, during a period Tⱼ₊₁ corresponding to the (j+1)-th line in which a scanning signal “OUTⱼ₊₁” is applied to the scanning electrodes Yⱼ₊₁ of the liquid crystal panel 14, a corresponding TFT 21_{i,j} is turned ON, causing the display signal Dᵢ to be applied to the liquid crystal molecules 22_{i,j} (writing by the TFT 21_{i,j}). At this time point, during the period T_{j+1,2} before completion of the response of each of the liquid crystal molecules 22_{i,j}, the backlight 15 is turned OFF and during the period T_{j+1,2} after the completion of the response, the backlight 15 is turned ON. Thereafter, similar processes are performed line-sequentially on each line.

Thus, according to the first embodiment, every time the driving pulse voltage “e” is generated by the backlight driving circuit 17 in synchronization with the timing signal “a” fed from the lighting timing control section 16 and the scanning signal “OUTⱼ” is line-sequentially to each of the scanning electrodes Yⱼ of the liquid crystal panel 14, the backlight 15 is turned OFF during the period before completion of the response of each of the liquid crystal molecules 22_{i,j} in response to application of the display signal Dᵢ and the backlight 15 is turned ON at time of the completion of the response and, therefore, when displacement of the liquid crystal molecules 22_{i,j} is large, and therefore the change in transmittance is large, no light is emitted through each of the liquid crystal molecules 22_{i,j} and no change in luminance on the display screen occurs, as a result, contrast of images can be improved.

### Second Embodiment

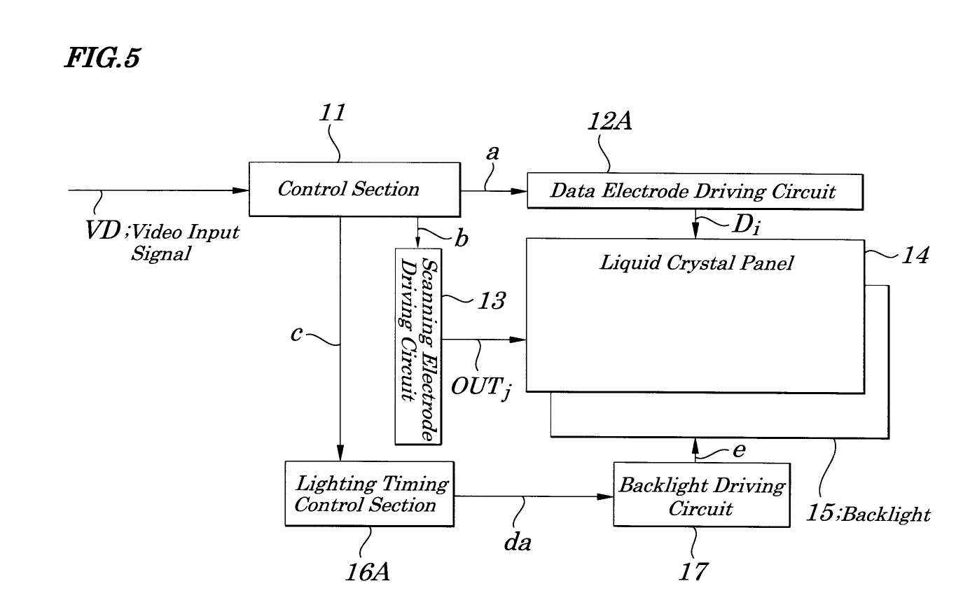

FIG. 5 is a block diagram showing electrical configurations of main components of a liquid crystal display device according to a second embodiment of the present invention. Each liquid crystal display device component shown in FIG. 5 is provided with the same reference number as the corresponding component in FIG. 4. In the liquid crystal display device, as shown in FIG. 5, instead of a data electrode driving circuit 12 and a lighting timing control section 16 shown in FIG. 1, a data electrode driving circuit 12A and a lighting timing control section 16A are provided. Functions of the data electrode driving circuit 12A and lighting timing control section 16A are different from those of the data electrode driving circuit 12 and the lighting timing control section 16. The data electrode driving circuit 12A applies, based on a control signal “a” fed from a control section 11, point-sequentially a display signal Dᵢ corresponding to a video input signal “VD” to each data electrode Xᵢ of a liquid crystal panel 14.

The lighting timing control section 16A generates, based on a control signal “c” fed from the control section 11, a timing signal “da” to turn a backlight 150N in a manner to correspond to a response characteristic of each of liquid crystal molecules 22_{i,j} to an applied voltage of the display signal Dᵢ. In the second embodiment in particular, every time the corresponding display signal Dᵢ is applied to each data electrode Xᵢ of the liquid crystal panel 14, the backlight 15 is turned OFF during a period before completion of the response of each of liquid crystal molecules 22_{i,j} in response to application of the display signal Dᵢ and the backlight 15 is turned ON at time of the completion of the response. Timing of turning the backlight 150N/OFF, as in the case of the lighting timing control section 16, is set in a manner to correspond to the response characteristic of each of the liquid crystal molecules 22_{i,j} and a turning-OFF period is set in a manner to correspond to a period during which displacement of the liquid crystal molecules 22_{i,j} is large and therefore the change in light transmittance is large and the turning-ON period is set in a manner to correspond to a period during which each of the liquid crystal molecules 22_{i,j} reach a steady state after the completion of displacement of the liquid crystal molecules 22_{i,j}. Operations other than the above are the same as those described by referring to FIG. 1.

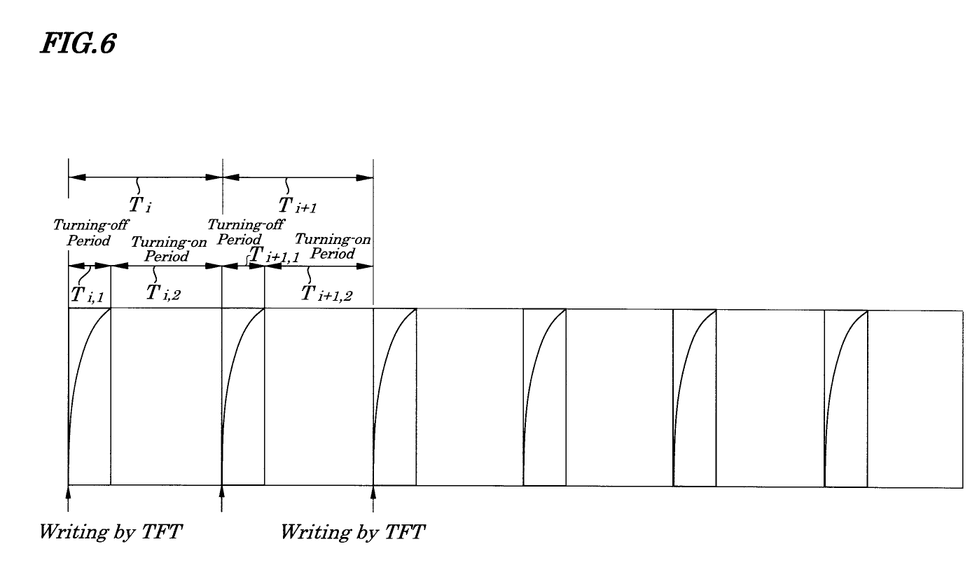

FIG. 6 is a time chart explaining operations of the liquid crystal display device of FIG. 5. Referring to FIG. 6, processes for the method of driving the liquid crystal display device of the second embodiment are described below. In the liquid crystal display device, every time a driving pulse voltage “e” is generated by the lighting timing control unit 16A in synchronization with the timing signal “da” fed from the lighting timing control section 16A and applied to the backlight 15 and the corresponding display signal Dᵢ is applied point-sequentially to each data electrode Xᵢ of the liquid crystal panel 14, the backlight 15 is turned OFF during a period before completion of the response of each of the liquid crystal molecules 22_{i,j} in response to application of the display signal Dᵢ and is turned ON at time of the completion of the response (light source driving process).

That is, as shown in FIG. 6, during a time period Tᵢ corresponding to an i-th pixel in which the corresponding display signal Dᵢ is applied to each data electrode Xᵢ of the liquid crystal panel 14, a corresponding TFT 21_{i,j} is turned ON and the display signal Dᵢ is fed to the liquid crystal molecules 22_{i,j} (writing by TFT 21_{i,j}). At this time point, the backlight 15 is turned OFF during a time period T_{i,1} before completion of the response of each of the liquid crystal molecules 22_{i,j} and is turned ON during a time period T_{i,2} after completion of the response of each of the liquid crystal molecules 22_{i,j}. Similarly, during a time period Tᵢ₊₁ corresponding to an (i+1)-th pixel in which a corresponding display signal Dᵢ₊₁ is applied to each data electrode Xᵢ₊₁ of the liquid crystal panel 14, a corresponding TFT 21_{i+1,j} is turned ON and the display signal Dᵢ₊₁ is fed to the liquid crystal molecules 22_{i+1,j} (writing by TFT 21_{i+1,j}). At this time point, the backlight 15 is turned OFF during a time period T_{i+1,1} before completion of the response of each of the liquid crystal molecules 22_{i+1,j} and is turned ON during a time period T_{i+1,2} after completion of the response of each of the liquid crystal molecules 22_{i+1,j}. Similar processes are performed point-sequentially on each pixel.

Thus, according to the second embodiment, every time the driving pulse voltage “e” is generated by a backlight driving circuit 17 in synchronization with a timing signal “da” fed from the lighting timing control section 16A and a corresponding display signal Dᵢ is applied point-sequentially to each data electrode Xᵢ of the liquid crystal panel 14, the backlight 15 is turned OFF during a period before completion of the response of each of the liquid crystal molecules 22_{i,j} in response to application of the display signal Dᵢ and is turned ON at time of the completion of the response and, therefore, a screen having approximately the same image quality as a CRT (Cathode Ray Tube) is displayed, as a result, reducing afterimages and improving contrast of images.

It is apparent that the present invention is not limited to the above embodiments but may be changed and modified without departing from the scope and spirit of the invention. For example, if a method in which black writing is performed or the backlight 15 is turned OFF at the latter half of each frame is employed in combination with the methods employed in each of the above embodiments, contrast of images is further improved. Moreover, in the lighting timing control sections 16, 16A, 16B, and 16C of the above embodiments, the timing of turning the backlight 150N or OFF is preset, however, the liquid crystal display device may be so configured that the timing of turning-ON or OFF the backlight is adjusted from the outside. In this case, also, the liquid crystal display device may be so configured that light transmittance of the liquid crystal molecules 22_{i,j} to an applied voltage of a display signal is calculated by using an optical sensor or a like to detect a response state of each of the liquid crystal molecules 22_{i,j} and the timing of turning-ON or OFF the backlight is controlled according to results from the detection. Besides the backlight, a side light may be also used as a light source. Moreover, in the case of a reflective-type liquid crystal display device, by applying the present invention to a front light, almost the same actions and effects as obtained in the above embodiments can be achieved. Furthermore, the present invention can be applied generally to a liquid crystal display device to display moving images such as a liquid crystal television set and a liquid crystal monitor for displaying moving images.

What is claimed is:

1. A liquid crystal display device comprising:
a light source,
a light source controlling unit, and
a liquid crystal panel,
wherein said liquid crystal panel comprises:
an active matrix substrate having a plurality of data electrodes arranged in parallel with one another at predetermined intervals along a first direction, a plurality of scanning electrodes arranged in parallel with one another at predetermined intervals along a second direction orthogonal to said first direction, and a plurality of pixel regions each being arranged in a manner to correspond, in a one-to-one relationship, to an intersection of the two electrodes, one being each of said plurality of data electrodes and another being each of said plurality of scanning electrodes;
a facing substrate mounted in a manner to face said active matrix substrate which has facing electrodes; and
a liquid crystal layer interposed between said active matrix substrate and said facing substrate; and
wherein, by application of a scanning signal to each of said plurality of scanning electrodes and of a display signal to each of said plurality of data electrodes, a specified voltage is applied to each of said plurality of pixel regions corresponding to said display signal and an orientation state of each liquid crystal molecule making up said liquid crystal layer is controlled by said voltage to be applied to obtain a display image; and
wherein said light source controlling unit controls timing of turning said light source ON/OFF according to a response characteristic of each said liquid crystal molecule to an applied voltage.

2. The liquid crystal display device according to claim 1, wherein said light source controlling unit turns said light source OFF during a period before completion of the response of each said liquid crystal molecule to the application of said display signal and turns said light source ON at time of the completion of said response.

3. The liquid crystal display device according to claim 1, further comprising:
a data electrode driving circuit to apply a corresponding display signal, by one operation, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source controlling unit turns OFF and ON said light source.

4. The liquid crystal display device according to claim 1, further comprising;
a data electrode driving circuit to apply a corresponding display signal point-sequentially to each of said plurality of data electrodes of said liquid crystal panel; and
a scanning electrode driving circuit to apply said scanning signal line-sequentially to each of said plurality of scanning electrodes of said liquid crystal panel;
wherein, every time said display signal is applied to each of said plurality of data electrodes, said light source controlling unit turns OFF and ON said light source.

5. A driving circuit for being used in a liquid crystal display device comprising:
a light source,
a light source controlling unit, and
a liquid crystal panel,
wherein said liquid crystal panel comprises:
an active matrix substrate having a plurality of data electrodes arranged in parallel with one another at predetermined intervals along a first direction, a plurality of scanning electrodes arranged in parallel with one another at predetermined intervals along a second direction orthogonal to said first direction, and a plurality of pixel regions each being arranged in a manner to correspond, in a one-to-one relationship, to an intersection of the two electrodes, one being each of said plurality of data electrodes and another being each of said plurality of scanning electrodes;
a facing substrate mounted in a manner to face said active matrix substrate which has facing electrodes; and
a liquid crystal layer interposed between said active matrix substrate and said facing substrate; and
wherein, by application of a scanning signal to each of said plurality of scanning electrodes and of a display signal to each of said plurality of data electrodes, a specified voltage is applied to each of said plurality of pixel regions corresponding to said display signal and an orientation state of each liquid crystal molecule making up said liquid crystal layer is controlled by said voltage to be applied to obtain a display image; and
wherein said light source controlling unit controls timing of turning said light source ON/OFF according to a response characteristic of each said liquid crystal molecule to an applied voltage.

6. The driving circuit according to claim 5, wherein said light source controlling unit turns said light source OFF during a period before completion of the response of each said liquid crystal molecule to the application of said display signal and turns said light source ON at time of the completion of said response.

7. The driving circuit according to claim 5, further comprising:
a data electrode driving circuit to apply a corresponding display signal, by one operation, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source driving unit turns said light source OFF and ON.

8. The driving circuit according to claim 5, further comprising:
a data electrode driving circuit to apply a corresponding display signal, point-sequentially, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source driving unit turns said light source OFF and ON.

9. A driving method for driving a liquid crystal display device comprising a light source, a light source controlling unit, and a liquid crystal panel, wherein said liquid crystal panel comprises an active matrix substrate having a plurality of data electrodes arranged in parallel with one another at predetermined intervals along a first direction, a plurality of scanning electrodes arranged in parallel with one another at predetermined intervals along a second direction orthogonal to said first direction, and a plurality of pixel regions each being arranged in a manner to correspond, in a one-to-one relationship, to an intersection of the two electrodes, one being each of said plurality of data electrodes and another being each of said plurality of scanning electrodes, a facing substrate mounted in a manner to face said active matrix substrate which has facing electrodes, a liquid crystal layer interposed between said active matrix substrate and said facing substrate, and wherein, by application of a scanning signal to each of said plurality of scanning electrodes and of a display signal to each of said plurality of data electrodes, a specified voltage is applied to each of said plurality of pixel regions corresponding to said display signal and an orientation state of each liquid crystal molecule making up said liquid crystal layer is controlled by said voltage to be applied to obtain a display image, said driving method comprising:
light source driving processing in which timing of turning said light source ON/OFF is controlled according to a response characteristic of each said liquid crystal molecule to an applied voltage.

10. The driving method according to claim 9, wherein, in said light source driving processing, said light source is turned off during a period before completion of the response of each said liquid crystal molecule to the application of said display signal and is turned ON at time of the completion of said response.

11. The driving method according to claim 9, further comprising:
a step of mounting a data electrode driving circuit to apply a corresponding display signal, by one operation, to each of said plurality of data electrodes of said liquid crystal panel; and
a step of mounting a scanning electrode driving circuit to apply said scanning signal line-sequentially to each of said plurality of scanning electrodes of said liquid crystal panel;
wherein, in said light source driving processing, every time said display signal is applied to each of said plurality of data electrodes, said light source is turned OFF and ON.

12. The driving method according to claim 9, further comprising:
a step of mounting a data electrode driving circuit to apply a corresponding display signal point-sequentially to each of said plurality of data electrodes of said liquid crystal panel; and
a step of mounting a scanning electrode driving circuit to apply said scanning signal line-sequentially to each of said plurality of scanning electrodes of said liquid crystal panel;
wherein, in said light source driving processing, every time said scanning signal is applied to each of said plurality of scanning electrodes, said light source is turned OFF and ON.

13. A liquid crystal display device comprising:
a light source,
a light source controlling means, and
a liquid crystal panel,
wherein said liquid crystal panel comprises:
an active matrix substrate having a plurality of data electrodes arranged in parallel with one another at predetermined intervals along a first direction, a plurality of scanning electrodes arranged in parallel with one another at predetermined intervals along a second direction orthogonal to said first direction, and a plurality of pixel regions each being arranged in a manner to correspond, in a one-to-one relationship, to an intersection of the two electrodes, one being each of said plurality of data electrodes and another being each of said plurality of scanning electrodes;
a facing substrate mounted in a manner to face said active matrix substrate which has facing electrodes; and
a liquid crystal layer interposed between said active matrix substrate and said facing substrate; and
wherein, by application of a scanning signal to each of said plurality of scanning electrodes and of a display signal to each of said plurality of data electrodes, a specified voltage is applied to each of said plurality of pixel regions corresponding to said display signal and an orientation state of each liquid crystal molecule making up said liquid crystal layer is controlled by said voltage to be applied to obtain a display image; and
wherein said light source controlling means controls timing of turning said light source ON/OFF according to a response characteristic of each said liquid crystal molecule to an applied voltage.

14. The liquid crystal display device according to claim 13, wherein said light source controlling means turns said light source OFF during a period before completion of the response of each said liquid crystal molecule to the application of said display signal and turns said light source ON at time of the completion of said response.

15. The liquid crystal display device according to claim 13, further comprising:
a data electrode driving circuit to apply a corresponding display signal, by one operation, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source controlling means turns OFF and ON said light source.

16. The liquid crystal display device according to claim 13, further comprising;
a data electrode driving circuit to apply a corresponding display signal point-sequentially to each of said plurality of data electrodes of said liquid crystal panel; and
a scanning electrode driving circuit to apply said scanning signal line-sequentially to each of said plurality of scanning electrodes of said liquid crystal panel;
wherein, every time said display signal is applied to each of said plurality of data electrodes, said light source controlling means turns OFF and ON said light source.

17. A driving circuit for being used in a liquid crystal display device comprising:
a light source,
a light source controlling means, and
a liquid crystal panel,
wherein said liquid crystal panel comprises:
an active matrix substrate having a plurality of data electrodes arranged in parallel with one another at predetermined intervals along a first direction, a plurality of scanning electrodes arranged in parallel with one another at predetermined intervals along a second direction orthogonal to said first direction, and a plurality of pixel regions each being arranged in a manner to correspond, in a one-to-one relationship, to an intersection of the two electrodes, one being each of said plurality of data electrodes and another being each of said plurality of scanning electrodes;
a facing substrate mounted in a manner to face said active matrix substrate which has facing electrodes; and
a liquid crystal layer interposed between said active matrix substrate and said facing substrate; and
wherein, by application of a scanning signal to each of said plurality of scanning electrodes and of a display signal to each of said plurality of data electrodes, a specified voltage is applied to each of said plurality of pixel regions corresponding to said display signal and an orientation state of each liquid crystal molecule making up said liquid crystal layer is controlled by said voltage to be applied to obtain a display image; and
wherein said light source controlling means controls timing of turning said light source ON/OFF according to a response characteristic of each said liquid crystal molecule to an applied voltage.

18. The driving circuit according to claim 17, wherein said light source controlling means turns said light source OFF during a period before completion of the response of each said liquid crystal molecule to the application of said display signal and turns said light source ON at time of the completion of said response.

19. The driving circuit according to claim 17, further comprising:
a data electrode driving circuit to apply a corresponding display signal, by one operation, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source driving means turns said light source OFF and ON.

20. The driving circuit according to claim 17, further comprising:
a data electrode driving circuit to apply a corresponding display signal, point-sequentially, to each of said plurality of data electrodes of said liquid crystal panel; and
a scanning electrode driving circuit to apply said scanning signal line-sequentially to each of said plurality of scanning electrodes of said liquid crystal panel;
wherein, every time said scanning signal is applied to each of said plurality of scanning electrodes, said light source driving means turns said light source OFF and ON.
